(19) United States
(12) Patent Application Publication
(10) Pub. No.: US 2025/0342293 A1
(43) Pub. Date: Nov. 6, 2025

(54) METHOD FOR PREDICTING AN INTERNAL CORROSION RATE OF AN OIL AND GAS PIPELINE BASED ON IWOA-SVM

(71) Applicant: Southwest Petroleum University, CHENGDU CITY (CN)

(72) Inventors: Youlv Li, CHENGDU CITY (CN); Hongye Jiang, CHENGDU CITY (CN); Pengzheng Lei, CHENGDU CITY (CN); Taolong Xu, CHENGDU CITY (CN); Fangzhou He, CHENGDU CITY (CN)

(21) Appl. No.: 19/074,969

(22) Filed: Mar. 10, 2025

(30) Foreign Application Priority Data
May 6, 2024 (CN) 202410549000.0

(51) Int. Cl. G06F 30/27

(52) U.S. Cl. CPC G06F 30/27

(57) ABSTRACT

The present invention discloses a method for predicting an internal corrosion rate of an oil and gas pipeline based on IWOA-SVM. The method comprises the following steps: S1. selecting factors that are representative of and correlated with internal corrosion behavior during operation of the oil and gas pipeline as input variables; S2. preprocessing the input variables and organizing the processed data into a dataset; S3. dividing the dataset into a training set and a test set; S4. establishing a corrosion rate prediction model for the oil and gas pipeline based on IWOA-SVM, and predicting the internal corrosion rate. The invention enhances the traditional whale algorithm and integrates it with the SVM method. The improvement includes introducing adaptive weights and nonlinear convergence factors, thereby balancing global search and local exploitation capabilities, making it have strong global search capabilities and is less likely to become trapped in local optima.

### FIELD

The present invention relates to the technical field of oil and gas pipeline transportation, in particular to a method for predicting an internal corrosion rate of an oil and gas pipeline based on IWOA-SVM.

### BACKGROUND

A pipeline is the primary means of long-distance, large-capacity fluid transportation. However, it is prone to damage and aging, which can lead to serious consequences in the event of accidents. Therefore, ensuring pipeline safety is critical. [symbol] is pipeline risk assessment. The prediction of internal corrosion helps operators conduct pipeline management, inspections, and maintenance, and is a focus of attention for both industry and researchers.

Improved Whale Optimization Algorithm (IWOA) is a novel swarm intelligence [symbol] article swarm optimization. IWOA simulates the hunting behavior of whales and optimizes search through processes such as searching, surrounding, chasing, and attacking prey in whale populations. It has a fast convergence speed and has been widely used in both industrial and academic fields. [symbol] corrosion in oil and gas pipeline, determining defect growth patterns under actual operating conditions can be challenging. Therefore, predicting corrosion rates is quite difficult. Therefore, it is imperative to explore new methods to improve the accuracy of predicting the internal corrosion rate.

### SUMMARY

To address the above issues, the present invention provides a method for predicting an internal corrosion rate of an oil and gas pipeline based on IWOA-SVM, comprising the following steps:
S1. selecting factors that are representative of and correlated with internal corrosion behavior during operation of the oil and gas pipeline as input variables;
S2. preprocessing the input variables and organizing the processed data into a [symbol]
S3. dividing the dataset into a training set and a test set; and
S4. establishing a corrosion rate prediction model for the oil and gas pipeline based on IWOA-SVM, and predicting the internal corrosion rate.

Further, in step S1, the factors that are representative of and correlated with [symbol] concentration, temperature, pH value, medium flow velocity, and Cl⁻ concentration.

Further, in step S2, the specific step for preprocessing the input variables involves data normalization. The calculation formula for data normalization is as follows:

$${X}^{′} = \frac{X - {X}_{m i n}}{{X}_{ma x} - {X}_{m i n}} ;$$

[symbol]

e input variable vector, Xₘₐₓ is the maximum value of the input variable vector, and X′ is the normalized input variable vector.

Further, in step S4, establishing the corrosion rate prediction model for the oil and gas pipeline based on IWOA-SVM specifically includes the following sub-steps: [symbol] of the oil and gas pipeline;
S42. improving the IWOA method; and
S43. optimizing the SVM using the improved IWOA method.

Further, step S41 specifically includes the following sub-steps: [symbol] e input-output relationship model;
S412. establishing constraint conditions to optimize the input-output relationship model; and
S413. introducing a kernel function and performing classification mapping on the

Further, in step S42, improving the IWOA method involves improving the calculation method for the convergence factor a, the method for local search update X(t+1) and the weight ω(t). The specific improvements are as follows: the optimized calculation formula for the convergence factor a is as follows:

$$a ( t ) = {a}_{ini} ( {a}_{ini} - {a}_{fin} ) tan ( \frac{π}{4} {( \frac{t}{{T}_{ma x}} )}^{2} ) ;$$

where aᵢₙᵢ and a_{fin} are the initial and final values of the convergence factor, and t is [symbol] terations. By changing the linearly varying inertia weight into a nonlinearly varying adaptive weight, the calculation formula for the local search update X(t+1) after changing is as follows:

$$X ( t + 1 ) = \{ \begin{matrix}ω ( t ) \cdot \dot{X} ( t ) - A D , p < 0.5 \\ D {e}^{bl} \cdot cos ( 2 π l ) + ω ( \dot{t} ) \cdot X ( t ) , p \geq 0.5\end{matrix} ;$$

where ω(t) is the adaptive weight that varies with the number of iterations t, ω(\dot{t}) [symbol] er of iterations, \dot{X}(t) is the current optimal individual position, X(t) is the current individual position, A is the coefficient vector, D is the distance between the current individual position and the optimal individual position, b is the spiral constant, l is a random number between [−1,1], and p is a random number between [0,1]. The calculation formula for the

$$ω ( t ) = {ω}_{ma x} - ( {ω}_{ma x} - {ω}_{m i n} ) sin ( \frac{π}{2} {( \frac{t}{{T}_{ma x}} )}^{3} ) ;$$

where ωₘₐₓ and ωₘᵢₙ are the maximum and minimum values of the inertia weight, respectively.

Furthermore, the calculation formula for ω(t) is as follows:

$$\text{?}$$

$$\text{?} \text{indicates text missing or illegible when filed}$$

where, ωₘₐₓ and ωₘᵢₙ are the maximum and minimum values of the inertia weight, respectively.

Further, in step S43, the specific implementation steps include:
B1. initializing the parameter weights and thresholds of SVM and initializing the [symbol]
B2. setting the population size N of humpback whales, the maximum number of iterations Tₘₐₓ, and the number of iterations t=0, and taking the SVM kernel parameter g and penalty factor C as the position vector of IWOA;
B3. updating the nonlinear convergence factor and the adaptive weight, calculating the coefficient vector A, and initializing the random numbers p and l;
B4. updating the position information of the humpback whales based on the value of A;
B5. checking whether the number of iterations has reached the maximum number [symbol]
B6. outputting the optimal solution and obtaining the optimal kernel parameter g and optimal penalty factor C.

Further, the step B5 specifically includes the following sub-steps: proceeding to step B6 when the number of iterations reaches the maximum number of iterations; and [symbol] B3 when the number of iterations has not reached the maximum number of iterations.

Further, the method also includes the step for evaluating the prediction results:
S5. evaluating the predicted results according to relevant evaluation metrics, wherein the relevant evaluation metrics specifically include the mean absolute [symbol] e coefficient of determination (R²).

Further, the calculation formula for the mean absolute percentage error (MAPE) is as follows:

$$M A P E = \frac{1}{n} {\sum }_{i = 1}^{n} \vert \frac{{y}_{i} - {\hat{y}}_{i}}{{y}_{i}} \vert ;$$

[symbol]

s follows:

$$RMSE = \sqrt{\frac{1}{n} {\sum }_{i = 1}^{n} {( {y}_{i} - {\hat{y}}_{i} )}^{2}} ;$$

the calculation formula for the coefficient of determination (R²) is as follows:

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - {\overline{y}}_{i} )}^{2}} ;$$

where n is the number of samples, y is the actual value, ŷ is the predicted value,

[symbol]

The present invention provides a method for predicting the internal corrosion rate of the oil and gas pipeline based on IWOA-SVM, which has the following beneficial effects:

The present invention improves the traditional whale method and combines it with the SVM method to propose an IWOA-SVM method. The improvements include [symbol] ancing global search and local exploitation capabilities, making it have both strong global search capabilities and less likely to fall into local optimal solutions. The present invention combines the improved WOA model with SVM to achieve high-precision prediction of internal corrosion of in-service oil and gas pipeline, thereby ensuring the safe operation

[symbol]

### BRIEF DESCRIPTION OF THE DRAWINGS

FIG. 1 is a flowchart of the method provided by the present invention.

FIG. 2 shows the actual values of the internal corrosion rate of the oil and gas [symbol] along with the predicted values by various SVM models.

### DETAILED DESCRIPTION

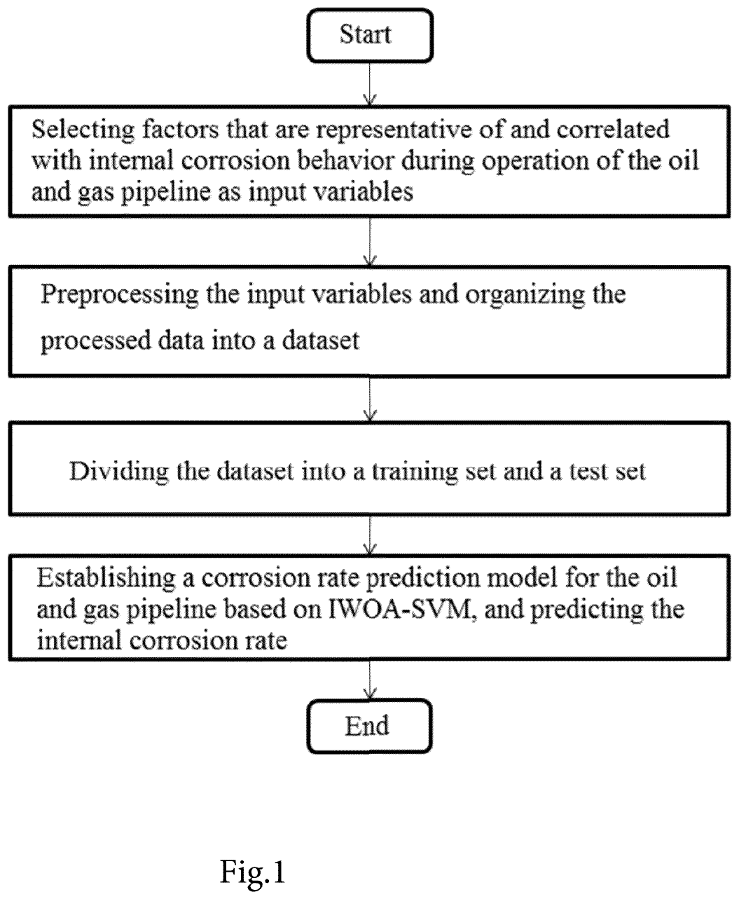

As illustrated in FIG. 1, the present invention provides a method for predicting the [symbol] comprising the following steps:
S1. selecting factors that are representative of and correlated with internal corrosion behavior during operation of the oil and gas pipeline as input variables;
S2. preprocessing the input variables and organizing the processed data into a [symbol]
S3. dividing the dataset into a training set and a test set; and
S4. establishing a corrosion rate prediction model for the oil and gas pipeline based on IWOA-SVM, and predicting the internal corrosion rate.

Wherein in step S1, the factors that are representative of and correlated with [symbol] concentration, temperature, pH value, medium flow velocity, and Cl-concentration.

In step S2, the specific step for preprocessing the input variables involves data normalization. The calculation formula for data normalization is as follows:

$${X}^{′} = \frac{X - {X}_{min}}{{X}_{max} - {X}_{min}} ;$$

where X is the input variable vector, Xₘᵢₙ is the minimum value of the input variable vector, Xₘₐₓ is the maximum value of the input variable vector, and X′ is the normalized input variable vector. [symbol] e oil and gas pipeline based on IWOA-SVM specifically includes the following sub-steps:
S41. using SVM as the basic model for the internal corrosion rate of the oil and gas pipeline;
S42. improving the IWOA method; and [symbol] d.

Wherein, in step S41 specifically includes the following sub-steps:
S411. setting the total number of samples and determining the input-output relationship model;
S412. establishing constraint conditions to optimize the input-output relationship [symbol]
S413. introducing a kernel function and performing classification mapping on the samples.

Using SVM as the basic model for the internal corrosion rate of the oil and gas pipeline: the basic idea of SVM is to find an optimal hyperplane that separates data [symbol] rplane has the maximum interval among all possible separating hyperplanes. The conceptual approach of the SVM method is described as follows:

For the i-th sample, the t input variables are represented as a vector: xᵢ=[xᵢ(1),xᵢ(2), . . . , xᵢ(t)]. The output variable corresponding to the i-th sample is

[symbol]

Assuming there are N samples in total, the relationship between input and output can be expressed as:

$$y = f ( x ) = ( w \cdot φ ( x ) ) + b ;$$

where w is the weight coefficient vector, ϕ (xᵢ) is the mapping from input space

[symbol]

To obtain a more accurate expression, the optimization objective can be determined under the following constraints:

$$\{ \begin{matrix}( w \cdot φ ( {x}_{i} ) ) + b - {y}_{i} \leq ε + {ξ}_{i} \\ {y}_{i} - ( w \cdot φ ( {x}_{i} ) ) - b \leq ε + {ξ}_{i}^{*} \\ {ξ}_{i} \geq 0 , {ξ}_{i}^{*} \geq 0 \\ i = 1 , 2 , … , N\end{matrix} ;$$

where ξ and ξ* are slack variables, and ε are insensitivity, which is the allowable range of error.

The optimization objective is as follows:

$$\text{?}$$

$$\text{?} \text{indicates text missing or illegible when filed}$$

where C is the penalty factor, representing the degree of penalty imposed on the sample when the insensitivity ε is exceeded, in order to balance the accuracy and complexity of the model.

By constructing a Lagrange function and introducing a kernel function K(xᵢ, xⱼ):

$$max \{ \text{?} {y}_{i} ( {α}_{i}^{*} - {α}_{i} ) - ε \text{?} ( {α}_{i}^{*} + {α}_{i} ) - \text{?} ( {α}_{i}^{*} - {α}_{i} ) ( {α}_{j}^{*} - {α}_{j} ) K ( {x}_{i} , {x}_{j} ) \} ;$$

$$\text{?} \text{indicates text missing or illegible when filed}$$

where aᵢ and aᵢ* are Lagrange coefficients, and K(xᵢ, xⱼ) is the kernel function. When using SVM to classify corrosion data samples, SVM maps the samples to a high-dimensional space using the kernel function.

The RBF kernel function is selected as the SVM kernel function, with its

[symbol]

$$K ( {x}_{i} , {x}_{j} ) = exp ( - g {‖ {F}_{i} - {F}_{j} ‖}^{2} ) g < 0 ;$$

where exp is the exponential function, g is the kernel parameter in the RBF kernel function, and the kernel parameter g along with the penalty factor C jointly determine the classification performance of the SVM.

[symbol]

A1. surrounding the target prey: taking the position of the humpback whale closest to the prey as the optimal solution, the remaining humpback whales aim to move closer to this optimal position, gradually updating their positions. The calculation formula is as follows:

$$\{ \begin{matrix}D = \vert C \cdot \dot{X} ( t ) - X ( t ) \vert \\ X ( t + 1 ) = \dot{X} ( t ) - A \cdot D \\ A = 2 a \cdot {r}_{1} - a \\ C = 2 {r}_{2}\end{matrix} ;$$

In the formula, \dot{X}(t) represents the position of the current optimal humpback whale, X(t) represents the position of the current humpback whale, t denotes the current number of iterations A and C are coefficient vectors, r₁ and r₂ are random vectors between [0,1], [symbol] whale and the optimal position, and a is a convergence factor that linearly decreases from 2 to 0 during the iteration process.

A2. spiral bubble-net attack: Humpback whales update their positions through contraction encirclement and spiral movement, gradually approaching the prey and [symbol] ovement of the humpback whale is as follows:

$$\{ \begin{matrix}X ( t + 1 ) = D \cdot {e}^{b l} \cdot cos ( 2 π l ) + \dot{X} ( t ) \\ D = \vert \dot{X} ( t ) - X ( t ) \vert\end{matrix} ;$$

Where, b is a constant of spiral shape, and l is a random number between [−1,1].

The calculation formula for updating spiral position or judging contraction

$$X ( t + 1 ) = \{ \begin{matrix}\dot{X} ( t ) - A \cdot D , p < 0.5 \\ D \cdot {e}^{bl} \cdot cos ( 2 π l ) + \dot{X} ( t ) , p \geq 0.5\end{matrix} ;$$

Where p is a random number between [0,1].

A3. searching and locking onto the target prey: Humpback whales can track prey not only through the spiral bubble-net method but also by searching for prey based on, [symbol] the reference for position updating switches from the position of the optimal humpback whale to the position of a randomly selected humpback whale, enabling global optimization. When the coefficient vector |A|<1, the humpback whale still updates its position with the optimal solution position and performs local optimization. The calculation formula is

$$\{ \begin{matrix}X ( t + 1 ) = {X}_{r a n d} ( t ) - A \cdot D \\ D = \vert C \cdot {X}_{r a n d} ( t ) - X ( t ) \vert\end{matrix} ;$$

Where X_{rand}(t) represents the position of the randomly selected whale.

The principle of IWOA method is simple and requires few parameters to be manually adjusted. However, the optimization ability of the method is entirely [symbol] more inclined the optimization ability of the method is towards local optimization. The larger the value of a, the more inclined the optimization ability of the method is towards to global optimization. The value of a varies linearly, which may cause the method to be trapped in local optimization. Therefore, introducing non-linear adjustment can improve the

[symbol]

A4. optimize the convergence factor a. The calculation formula for the optimized convergence factor a is as follows:

$$a ( t ) = {a}_{ini} ( {a}_{ini} - {a}_{fin} ) tan ( \frac{π}{4} {( \frac{t}{{T}_{max}} )}^{2} ) ;$$

Where aᵢₙᵢ and a_{fin} represent the initial and final values of the convergence factor,

[symbol]

When a nonlinear convergence factor is introduced, the linear variation of the inertia weight no longer enables the method to achieve better optimization performance.

A5. by changing the linearly varying inertia weight into a nonlinearly varying adaptive weight, the updated calculation formula is as follows:

$$X ( t + 1 ) = \{ \begin{matrix}ω ( t ) \cdot \dot{X} ( t ) - A \cdot D , p < 0.5 \\ \text{?}\end{matrix} ;$$

$$\text{?} \text{indicates text missing or illegible when filed}$$

Where ω(t) is the adaptive weight that varies with the number of iterations t, ω(t) is the rate at which the inertia weight dynamically changes with the number of iterations.

In step A5, the calculation formula for ω(t) is as follows:

$$ω ( t ) = {ω}_{max} - ( {ω}_{max} - {ω}_{min} ) sin ( \frac{π}{2} {( \frac{t}{{T}_{max}} )}^{3} ) ;$$

where ωₘₐₓ and ωₘᵢₙ are the maximum and

[symbol]

In step S43, the specific implementation steps include:

B1. initializing the parameter weights and thresholds of SVM and initializing the IWOA.

B2. setting the population size N of humpback whales, the maximum number of iterations Tₘₐₓ, and the number of iterations t=0, and taking the SVM kernel parameter g and penalty factor C as the position vector of IWOA. [symbol] ht, calculating the coefficient vector A, and initializing the random numbers p and l. Update the nonlinear convergence factor a according to the formula

$$a ( t ) = {a}_{ini} ( {a}_{ini} - {a}_{fin} ) tan ( \frac{π}{4} {( \frac{t}{{T}_{max}} )}^{2} ) ,$$

update the adaptive weight according to the formula

$$X ( t + 1 ) = \{ \begin{matrix}ω ( t ) \cdot \dot{X} ( t ) - A \cdot D , & p < 0.5 \\ D \cdot {e}^{bl} \cdot cos ( 2 π l ) + ω ( \dot{t} ) \cdot X ( t ) , & p \geq 0.5\end{matrix} ,$$

and substitute the

[symbol]

$$\{ \begin{matrix}D = \vert C \cdot \dot{X} ( t ) - X ( t ) \vert \\ X ( t + 1 ) = \dot{X} ( t ) - A \cdot D \\ A = 2 a \cdot {r}_{1} - a \\ C = 2 {r}_{2}\end{matrix}$$

to calculate the coefficient vector A.

B4. updating the position information of the humpback whales based on the value of A.

When |A|≥1, update the position information according to the formula for p<0.5 in

$$\{ \begin{matrix}X ( t + 1 ) = D \cdot {e}^{bl} \cdot cos ( 2 π l ) + \dot{X} ( t ) \\ D = \vert \dot{X} ( t ) - X ( t ) \vert\end{matrix}$$

the position information according to

$$X ( t + 1 ) = \{ \begin{matrix}ω ( t ) \cdot \dot{X} ( t ) - A \cdot D , & p < 0.5 \\ D \cdot {e}^{bl} \cdot cos ( 2 π l ) + ω ( \dot{t} ) \cdot X ( t ) , & p \geq 0.5\end{matrix} .$$

B5. checking whether the number of iterations has reached the maximum number of iterations. When the number of iterations reaches the maximum number of iterations, proceed to step B6; when the number of iterations has not reached the maximum and repeat step [symbol] B3.

B6. outputting the optimal solution and obtaining the optimal kernel parameter g and optimal penalty factor C.

In the method described in the present invention, the optimal kernel parameter g and the optimal penalty factor C are obtained, which can be used to configure the SVM model for predicting the corrosion rate. The specific steps include: [symbol] optimal penalty factor C to the initialization configuration of the SVM.

Data preparation: prepare the training set and factors that are representative of and correlated with input internal corrosion behavior.

Model training: train SVM using the prepared training set and configured

[symbol]

Model Validation: validate the performance and predictive ability of the model by using the test set to ensure the model can accurately predict corrosion rate.

Application prediction: predict corrosion rate on new or unknown data by using the trained model. Input feature into the model to obtain predicted value of corrosion

[symbol]

Furthermore, the method also includes the step for evaluating the prediction results: S5. evaluating the predicted results according to relevant evaluation metrics, wherein the relevant evaluation metrics specifically include the mean absolute percentage error (MAPE), the root mean square error (RMSE), and the coefficient of determination (R²). [symbol] ercentage error (MAPE) is as follows:

$$MAPE = \frac{1}{n} {\sum }_{i = 1}^{n} \vert \frac{{y}_{i} - {\hat{y}}_{i}}{{y}_{i}} \vert ;$$

the calculation formula for the root mean square error (RMSE) is as follows:

$$RMSE = \sqrt{\frac{1}{n} {\sum }_{i = 1}^{n} {( {y}_{i} - {\hat{y}}_{i} )}^{2}} ;$$

[symbol]

as follows:

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - {\overline{y}}_{i} )}^{2}} ;$$

where n is the number of samples, y is the actual value, ŷ is the predicted value, and y̅ is the average of the actual values.

Among the three evaluation methods mentioned above, the smaller the mean absolute percentage error (MAPE) and root mean square error (RMSE), the more [symbol] e accurate the prediction result is.

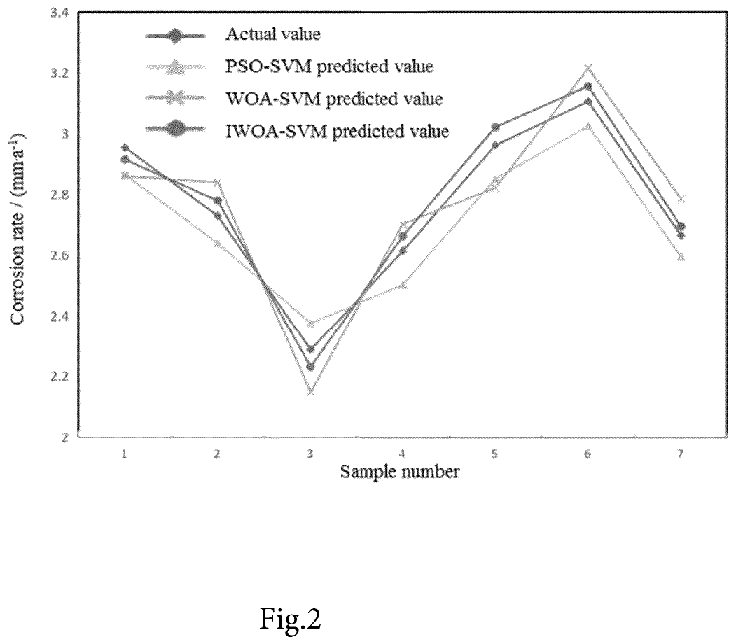

To demonstrate the superiority of the IWOA-SVM established by the method of the present invention over other methods, PSO-SVM and WOA-SVM models for predicting the internal corrosion rate of the oil and gas pipeline were simultaneously [symbol] und the specific results are shown in FIG. 2. The overall prediction results of the IWOA-SVM model are closer to the true values, and the model exhibits strong stability. The mean absolute percentage error (MAPE) and root mean square error (RMSE) of the PSO-SVM, WOA-SVM, and IWOA-SVM models for predicting the internal corrosion rate of the oil and [symbol] R² value of the IWOA-SVM is 0.9806, which is the closest to 1 among all the models, while the root mean square error (RMSE) is 0.0450 and the mean absolute percentage error (MAPE) is 1.6202, which is the smallest among all models. From this, it can be concluded that the IWOA-SVM model has better prediction accuracy and generalization ability [symbol] ce for internal corrosion rate for relevant personnel.

TABLE 1
Comparison of Model Prediction Performance Evaluation Metrics

| | R² | RMSE | MAPE |
|---|---|---|---|
| PSO-SVM | 0.8851 | 0.0989 | 3.4932 |
| WOA-SVM | 0.9279 | 0.1080 | 3.8141 |
| IWOA-SVM | 0.9806 | 0.0450 | 1.6202 |

The present invention improves the traditional whale method and combines it with [symbol] ments include introducing adaptive weights and nonlinear convergence factors, balancing global search and local exploitation capabilities, making it have both strong global search capabilities and less likely to fall into local optimal solutions. The present invention combines the improved WOA model with SVM to achieve high-precision prediction of internal corrosion of in-service oil and gas pipeline, thereby ensuring the safe operation of in-service oil and gas pipeline.

What is claimed is:

1. A method for predicting an internal corrosion rate of an oil and gas pipeline [symbol]
S1. selecting factors that are representative of and correlated with internal corrosion behavior during operation of the oil and gas pipeline as input variables;
S2. preprocessing the input variables and organizing the processed data into a dataset; [symbol]
S4. establishing a corrosion rate prediction model for the oil and gas pipeline based on IWOA-SVM, and predicting the internal corrosion rate.

2. The method for predicting the internal corrosion rate of the oil and gas pipeline based on IWOA-SVM of claim 1, wherein in step S1, the factors that are representative [symbol] pressure, CO₂ concentration, temperature, pH value, medium flow velocity, and Cl⁻ concentration.

3. The method for predicting the internal corrosion rate of the oil and gas pipeline based on IWOA-SVM of claim 1, wherein in step S2, the specific step for preprocessing the input variables involves data normalization, wherein the calculation formula for
$${X}^{′} = \frac{X - {X}_{min}}{{X}_{max} - {X}_{min}} ;$$
where X is the input variable vector, Xₘᵢₙ is the minimum value of the input variable vector, Xₘₐₓ is the maximum value of the input variable vector, and X′ is the normalized input variable vector. [symbol] nd gas pipeline based on IWOA-SVM of claim 1, wherein in step S4, establishing the corrosion rate prediction model for the oil and gas pipeline based on IWOA-SVM specifically includes the following sub-steps:
S41. using SVM as a basic model for the internal corrosion rate of the oil and gas pipeline;
S42. improving the IWOA method; and
S43. optimizing the basic model using the improved IWOA method.

5. The method for predicting the internal corrosion rate of the oil and gas pipeline [symbol] the following sub-steps:
S411. setting the total number of samples and determining the input-output relationship model;
S412. establishing constraint conditions to optimize the input-output relationship [symbol]
S413. introducing a kernel function and performing classification mapping on the samples.

6. The method for predicting the internal corrosion rate of the oil and gas pipeline based on IWOA-SVM of claim 4, wherein in step S42, improving the IWOA method [symbol] a in the IWOA method, the method for local search update X(t+1) and the weight ω(t), the specific improvements are as follows:
the optimized calculation formula for the convergence factor a is as follows:
$$a ( t ) = {a}_{ini} ( {a}_{r} - {a}_{fin} ) tan ( \frac{π}{4} {( \frac{t}{{T}_{max}} )}^{2} ) ;$$ [symbol]
factor, and t is the current number of iterations, Tₘₐₓ is the maximum number of iterations;
by changing the linearly varying inertia weight into a nonlinearly varying adaptive weight, the calculation formula for the local search update X(t+1) after changing is as follows:
$$\text{?}$$
$$\text{?} \text{indicates text missing or illegible when filed}$$
where ω(t) is the adaptive weight that varies with the number of iterations t, ω(\dot{t}) is the rate at which the inertia weight dynamically changes with the number of iterations, \dot{X}(t) is the current optimal individual position, X(t) is the current individual position, A is the coefficient vector, D is the distance between the current individual position and the optimal individual position, b is the spiral constant, l is a random number between [−1,1], and p is a random number between [0,1];
the calculation formula for the adaptive weight ω(t) is as follows:
$$\text{?}$$
$$\text{?} \text{indicates text missing or illegible when filed}$$
where ωₘₐₓ and ωₘᵢₙ are the maximum and minimum values of the inertia weight, respectively.

7. The method for predicting the internal corrosion rate of the oil and gas pipeline based on IWOA-SVM of claim 4, wherein in step S43, the specific implementation [symbol]
B1. initializing the parameter weights and thresholds of SVM and initializing the IWOA;
B2. setting the population size N of individuals, the maximum number of iterations Tₘₐₓ, and the number of iterations t=0, and taking the SVM kernel parameter g and [symbol]
B3. updating the nonlinear convergence factor and the adaptive weight, calculating the coefficient vector A, and initializing the random numbers;
B4. updating the position information of the individuals based on the value of A;
B5. checking whether the number of iterations has reached the maximum number [symbol]
B6. outputting the optimal solution and obtaining the optimal kernel parameter g and optimal penalty factor C.

8. The method for predicting the internal corrosion rate of the oil and gas pipeline based on IWOA-SVM of claim 7, wherein the step B5 specifically includes the [symbol]
proceeding to step B6 when the number of iterations reaches the maximum number of iterations; and
incrementing the current number of iterations by one and repeat step B3 when the number of iterations has not reached the maximum number of iterations.

9. The method for predicting the internal corrosion rate of the oil and gas pipeline based on IWOA-SVM of claim 1, wherein the method also includes the step for evaluating the prediction results: S5. evaluating the predicted results according to relevant evaluation metrics, wherein the relevant evaluation metrics specifically include [symbol] (RMSE), and the coefficient of determination (R²).

10. The method for predicting the internal corrosion rate of the oil and gas pipeline based on IWOA-SVM of claim 9, wherein the calculation formula for the mean absolute percentage error (MAPE) is:
$$MAPE = \frac{1}{n} {\sum }_{i = 1}^{n} \vert \frac{{y}_{i} - {\hat{y}}_{i}}{{y}_{i}} \vert ;$$
the calculation [symbol] RMSE) is:
$$RMSE = \sqrt{\frac{1}{n} {\sum }_{i = 1}^{n} {( {y}_{i} - {\hat{y}}_{i} )}^{2}} ;$$
the calculation formula for the coefficient of [symbol] determination (R²) is:
$${R}^{2} = 1 - \frac{{\sum }_{i = 1}^{n} {( {y}_{i} - {\hat{y}}_{i} )}^{2}}{{\sum }_{i = 1}^{n} {( {y}_{i} - {\overline{y}}_{i} )}^{2}} ;$$
where n is the number of samples, y is the actual value, ŷ is the predicted value, and y̅ is the average of the actual values.
